(19) United States
(12) Patent Application Publication
(10) Pub. No.: US 2023/0278756 A1
(43) Pub. Date: Sep. 7, 2023

(54) Beverage Bottle Sealing Assembly

(71) Applicants: Graham Eves, Temecula, CA (US); Holly Eves, Temecula, CA (US)

(72) Inventors: Graham Eves, Temecula, CA (US); Holly Eves, Temecula, CA (US)

(21) Appl. No.: 17/688,490

(22) Filed: Mar. 7, 2022

(51) Int. Cl. B65D 41/04; B65D 1/02; B67B 3/20

(52) U.S. Cl. CPC B65D 41/045; B65D 1/0246; B67B 3/20

(57) ABSTRACT

A beverage bottle sealing assembly includes a beverage bottle that has a neck. A cap is removably engaged to the beverage bottle for closing the beverage bottle. An elongate panel is provided and the elongate panel is comprised of a non-adhesive material. A plurality of disks is each removably adhered to the elongate panel. A respective one of the disks is removable from the elongate panel and positioned over the beverage bottle when the cap has been removed from the beverage bottle. Furthermore, each of the disks is comprised of a compressible material thereby facilitating the disks to form a fluid impermeable seal between the beverage bottle and the cap. In this way the disk that is positioned on the beverage bottle retains freshness of a beverage contained in the beverage bottle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to bottle sealing devices and more particularly pertains to a new bottle sealing device for sealing a beverage bottle when the beverage bottle has already been opened. The device includes a beverage bottle that has a neck and a cap that is threadable onto the neck. The device includes an elongate panel and a plurality of disks that is removably adhered to the elongate panel. Each of the disks is comprised of a compressible material. Furthermore, a respective one of the disks is positionable over the neck and the cap is positioned on the beverage bottle. The respective disk forms a fluid impermeable seal between the beverage bottle and the cap to retain freshness of unconsumed beverage in the beverage bottle.

### (2) Description of Related Art Including Information Disclosed Under 37 CFR 1.97 and 1.98

The prior art relates to bottle sealing devices including an elastic cap for a beverage bottle for resealing the beverage bottle. The prior art discloses a variety of lids for fluid containers that each forms a fluid impermeable seal with the fluid container for retaining freshness of the fluid in the fluid container. The prior art discloses a container lid that has a flexible panel integrated into the container lid for forming a fluid impermeable seal with a container. The prior art discloses a bottle cap device that includes a bottle cap, a glass insert disposed on the silicone cap and a silicone gasket disposed on the glass insert.

### BRIEF SUMMARY OF THE INVENTION

An embodiment of the disclosure meets the needs presented above by generally comprising a beverage bottle that has a neck. A cap is removably engaged to the beverage bottle for closing the beverage bottle. An elongate panel is provided and the elongate panel is comprised of a non-adhesive material. A plurality of disks is each removably adhered to the elongate panel. A respective one of the disks is removable from the elongate panel and positioned over the beverage bottle when the cap has been removed from the beverage bottle. Furthermore, each of the disks is comprised of a compressible material thereby facilitating the disks to form a fluid impermeable seal between the beverage bottle and the cap. In this way the disk that is positioned on the beverage bottle retains freshness of a beverage contained in the beverage bottle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an exploded perspective view of a beverage bottle sealing assembly according to an embodiment of the disclosure.

FIG. 2 is a perspective view of an embodiment of the disclosure showing a disk being positioned on a neck of a beverage bottle.

FIG. 3 is a perspective in-use view of an embodiment of the disclosure showing a disk being compressed between a beverage bottle and a cap on the beverage bottle.

FIG. 4 is a perspective view of an elongate panel of an embodiment of the disclosure and a plurality of disks each being removably adhered to the elongate panel.

### DETAILED DESCRIPTION OF THE INVENTION

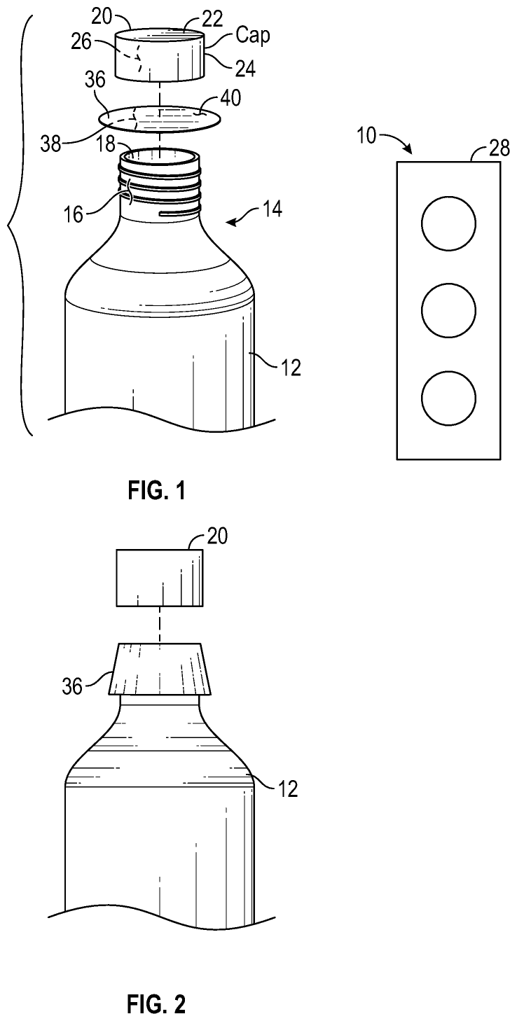

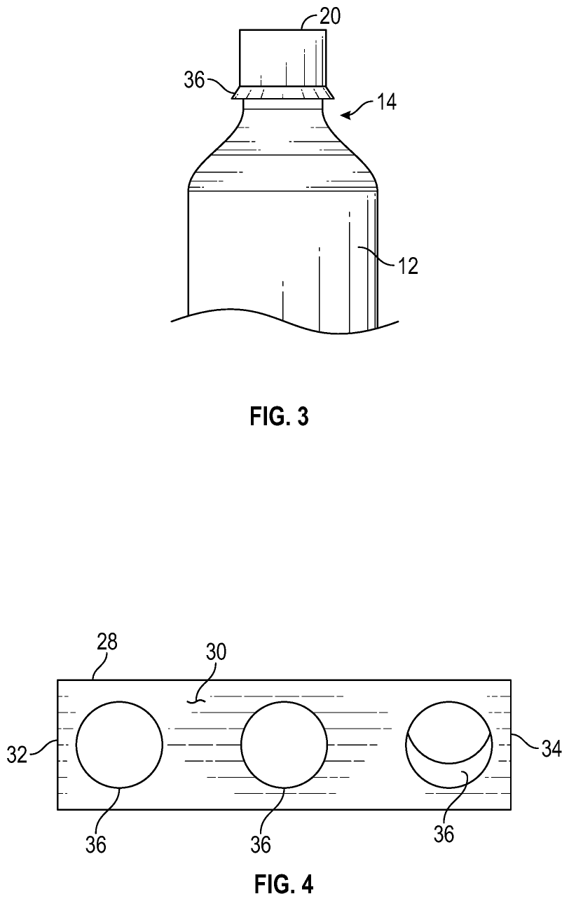

With reference now to the drawings, and in particular to FIGS. 1 through 4 thereof, a new bottle sealing device embodying the principles and concepts of an embodiment of the disclosure and generally designated by the reference numeral 10 will be described.

As best illustrated in FIGS. 1 through 4, the beverage bottle sealing assembly 10 generally comprises a beverage bottle 12 that has a neck 14. The neck 14 has an outer surface 16 and an open end 18, and the outer surface 16 is threaded. The beverage bottle 12 may be a soda bottle, a beer bottle or any other commercially produced beverage bottle that contains a beverage. A cap 20 is removably engaged to the beverage bottle 12 for closing the beverage bottle 12. The cap 20 has a top wall 22 and an outer wall 24 extending downwardly from the top wall 22, and the outer wall 24 has an inside surface 26 that is threaded. The inside surface 26 threadably engages the outer surface 16 of the neck 14 has the top wall 22 resting on the open end 18 of the beverage bottle 12 when the cap 20 is threaded onto the beverage bottle 12.

An elongate panel 28 is provided and the elongate panel 28 is longitudinally elongated. The elongate panel 28 is comprised of a deformable material and the elongate panel 28 is comprised of a translucent material, which may comprise plastic or other similar material. Furthermore, the elongate panel 28 is comprised of a non-adhesive material. The elongate panel 28 has an upper surface 30, a first end 32 and a second end 34, and the elongate panel 28 is elongated between the first end 32 and the second end 34.

A plurality of disks 36 is provided and each of the disks 36 is removably adhered to the elongate panel 28. A respective one of the disks 36 is removable from the elongate panel 28 and positioned over the beverage bottle 12 when the cap 20 has been removed from the beverage bottle 12. Each of the disks 36 is comprised of a compressible material, including but not being limited to rubber or silicone, thereby facilitating the disks 36 to form a fluid impermeable seal between the beverage bottle 12 and the cap 20. In this way the plurality of disks 36 can retain freshness of the beverage contained in the beverage bottle 12.

Each of the disks 36 has a bottom surface 38 and a top surface 40, and the bottom surface 38 of each of the disks 36 is removably adhered to the upper surface 30 of the elongate panel 28. The disks 36 are spaced apart from each other and are distributed between the first end 32 and the second end 34. The bottom surface 38 of the disk 36 that is removed from the elongate panel 28 is positioned on the open end 18 of the neck 14 of the beverage bottle 12. Furthermore, the disk 36 that is removed from the elongate panel 28 is folded downwardly over the outer surface 16 of the neck 14. In this way the disk 36 that is positioned on the open end 18 of the neck 14 of the beverage bottle 12 is compressed between the open end 18 of the neck 14 of the beverage bottle 12 and the cap 20 when the cap 20 is threaded onto the neck 14. The bottom surface 38 of each of the disks may comprise a mild adhesive for adhering the disks to the elongate panel 28.

In use, the cap 20 is initially removed from the neck 14 of the beverage bottle 12 to facilitate the beverage to be consumed. A respective one of the disks 36 is removed from the elongate panel 28 and the respective disk 36 is positioned on the neck 14 of the beverage bottle 12 when the beverage has not been fully consumed. Additionally, the respective disk 36 is folded downwardly along the neck 14 and the cap 20 is threaded onto the neck 14. In this way the respective disk 36 is compressed between the cap 20 and the neck 14 to form a fluid impermeable seal between the cap 20 and the beverage bottle 12. Thus, the freshness of the beverage can be maintained until the cap 20 is later removed to facilitate the remaining beverage to be consumed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

1. A beverage bottle sealing assembly comprising:
a beverage bottle having a neck, said neck having an open end;
a cap being removably engaged to said beverage bottle for closing said beverage bottle;
an elongate panel, said elongate panel being longitudinally elongated, said elongate panel being comprised of a deformable material, said elongate panel being comprised of a translucent material, said elongate panel being comprised of a non-adhesive material; and
a plurality of disks, each of said disks being removably adhered to said elongate panel, a respective one of said disks being removable from said elongate panel and positioned over said beverage bottle when said cap has been removed from said beverage bottle, each of said disks being continuous within an outer perimeter of said disk wherein each disk fully covers said open end of said neck When said disk is positioned extending over said open end, each of said disks being comprised of a compressible material thereby facilitating said disks to form a fluid impermeable seal between said beverage bottle and said cap wherein said plurality of disks are configured to retain freshness of a beverage contained in said beverage bottle.

2. The assembly according to claim 1, wherein:
said neck has an outer surface, said outer surface being threaded;
said cap having a top wall and an outer wall extending downwardly from said top wall, said outer wall having an inside surface being threaded, said inside surface threadably engaging said outer surface of said neck having said top wall resting on said open end of said beverage bottle when said cap is threaded onto said beverage bottle.

3. The assembly according to claim 1, wherein:
said elongate panel has an upper surface, a first end and a second end, said elongate panel being elongated between said first end and said second end; and
each of said disks has a bottom surface and a top surface, said bottom surface of each of said disks being removably adhered to said upper surface of said elongate panel, said disks being spaced apart from each other and being distributed between said first end and said second end.

4. The assembly according to claim 3, wherein:
said neck has an outer surface and an open end, said outer surface being threaded; and
said bottom surface of said disk that is removed from said elongate panel being positioned on said open end of said neck of said beverage bottle having said disk that is removed from said elongate panel being folded downwardly over said outer surface of said neck.

5. The assembly according to claim 4, wherein said disk that is positioned on said open end of said neck of said beverage bottle being compressed between said open end of said neck of said beverage bottle and said cap when said cap is threaded onto said neck.

6. A beverage bottle sealing assembly for sealing a beverage bottle after the beverage bottle has been opened, said assembly comprising:
a beverage bottle having a neck, said neck having an outer surface and an open end, said outer surface being threaded;
a cap being removably engaged to said beverage bottle for closing said beverage bottle, said cap having a top wall and an outer wall extending downwardly. from said top wall, said outer wall having an inside surface being threaded, said inside surface threadably engaging said outer surface of said neck having said top wall resting on said open end of said beverage bottle when said cap is threaded onto said beverage bottle;
an elongate panel, said elongate panel being longitudinally elongated, said elongate panel being comprised of a deformable material, said elongate panel being comprised of a translucent material, said elongate panel being comprised of a non-adhesive material, said elongate panel having an upper surface, a first end and a second end, said elongate panel being elongated between said first end and said second end; and
a plurality of disks, each of said disks being removably adhered to said elongate panel, a respective one of said disks being removable from said elongate panel and positioned over said beverage bottle when said cap has been removed from said beverage bottle, each of said disks being continuous within an outer perimeter of said disk wherein each disk fully covers said open end of said neck when said disk is positioned extending over said open end, each of said disks being comprised of a compressible material thereby facilitating said disks to form a fluid impermeable seal between said beverage bottle and said cap wherein said plurality of disks are configured to retain freshness of a beverage contained in said beverage bottle, each of said disks having a bottom surface and a top surface, said bottom surface of each of said disks being removably adhered to said upper surface of said elongate panel, said disks being spaced apart from each other and being distributed between said first end and said second end, said bottom surface of said disk that is removed from said elongate panel being positioned on said open end of said neck of said beverage bottle having said disk that is removed from said elongate panel being folded downwardly over said outer surface of said neck, said disk that is positioned on said open end of said neck of said beverage bottle being compressed between said open end of said neck of said beverage bottle and said cap when said cap is threaded onto said neck.

7. A method of resealing a beverage bottle that has been opened, the steps of the method comprising:
providing a beverage bottle having a neck, said neck having an open end and an outer surface;
providing a cap having a top wall and an outer wall extending downwardly from said top wall, said outer wall threadably engaging said outer surface of said neck such that said cap closes said beverage bottle;
providing an elongate panel having a top surface;
providing a plurality of disks each having a bottom surface, said bottom surface of each of said disks being removably adhered to said top surface of said elongate panel, each of said disks being continuous within an outer perimeter of said disk each of said disks being comprised of a compressible material;
removing said cap from said neck of said bottle;
removing a respective one of said disks from said elongate panel;
placing said bottom surface of said respective disk on said open end of said neck wherein said disk fully covers said open end of said neck;
folding said disk downwardly along said outer surface of said neck; and
screwing said cap onto said neck such that said disk is compressed between said cap and said neck thereby sealing said beverage bottle.
